(19) United States
(12) Patent Application Publication
(10) Pub. No.: US 2012/0150386 A1
(43) Pub. Date: Jun. 14, 2012

(54) METHOD FOR OPERATING AT LEAST ONE SENSOR OF A VEHICLE AND DRIVER ASSISTANCE SYSTEM FOR A VEHICLE

(75) Inventor: Markus ARMBRUST, Wonsheim (DE)

(73) Assignee: GM GLOBAL TECHNOLOGY OPERATIONS LLC, Detroit, MI (US)

(21) Appl. No.: 13/315,860

(22) Filed: Dec. 9, 2011

(30) Foreign Application Priority Data
Dec. 10, 2010 (DE) 10 2010 054 066.8

(51) Int. Cl. G06F 7/00; G08G 1/16

(52) U.S. Cl. 701/36; 701/301

(57) ABSTRACT

A method is provided for operating at least one first sensor of a vehicle traveling on a roadway. The first sensor is configured for detecting objects within a detection range and the method includes, but is not limited to determining a course of the roadway in a region of an instantaneous environment of the vehicle with map data stored in a storage apparatus. In addition, it is determined whether the roadway in the direction of travel of the vehicle has a bend based on the determined course of the roadway. If is determined that the roadway has a bend in the direction of travel of the vehicle, the at least one first sensor is adapted in such a manner that the detection range of the at least one first sensor in the region of the determined bend is aligned in the direction of the course of the bend.

### CROSS-REFERENCE TO RELATED APPLICATION

This application claims priority to German Patent Application No. 10 2010 054 066.8, filed Dec. 10, 2010, which is incorporated herein by reference in its entirety.

### TECHNICAL FIELD

The technical field relates to a method for operating at least one first sensor of a vehicle traveling on a roadway, a driver assistance system for a vehicle, a computer program product, and a computer-readable medium.

### BACKGROUND

Known from DE 10 2008 002 585 A1 is a swiveling headlamp system, in particular for a vehicle having at least one headlamp. The swiveling headlamp system has an operating unit for adjusting an angular position of the at least one headlight and a control unit for controlling the angular adjustment of the at least one headlight. Signals can be received by the control unit for determining the desired value of the angular position of a headlight, which signals comprise a vehicle speed and/or a steering angle and route data at least of the subsequently drivable stretch of road. The angular position of the headlight is adjustable based on this data.

It is at least one object to provide a method for operating at least one first sensor of a vehicle traveling on a roadway, a driver assistance system for a vehicle, a computer program product, and a computer-readable medium, which enables an improved determination of an instantaneous traffic situation. In addition, other objects, desirable features, and characteristics will become apparent from the subsequent summary and detailed description, and the appended claims, taken in conjunction with the accompanying drawings and this background.

### SUMMARY

A method for operating at least one first sensor of a vehicle traveling on a roadway, where the at least one first sensor is configured for detecting objects within a detection range according to one aspect of the application comprises the following steps. A course of the roadway is determined at least in a region of an instantaneous environment of the vehicle by means of map data stored in a storage apparatus. In addition, it is determined whether the roadway in the direction of travel of the vehicle has a bend, based on the determined course of the roadway. If it is determined that the roadway has a bend in the direction of travel of the vehicle, the at least one first sensor is adapted in such a manner that the detection range of the at least one first sensor in the region of the determined bend is aligned in the direction of the course of the bend. In this context, here and subsequently, the direction of the course of the bend is understood to be the direction of the curvature of the bend, i.e., the direction of the course of the bend is to the right in the case of a right-hand bend and to the left in the case of a left-hand bend.

The method for operating the at least one first sensor according to the embodiment enables an improved determination of an instantaneous traffic situation whereby an adaptation of the at least one first sensor is accomplished when determining a bend in such a manner that the detection range is aligned in the area of the determined bend in the direction of the course of the bend. The application starts from the consideration that when the vehicle is driving round a bend, in particular in the case of bends having small radii of curvature, the detection range of a fixed sensor cannot or cannot sufficiently cover the area of the roadway lying ahead in the direction of travel of the vehicle. By aligning the detection range according to the said embodiment, this area of the environment of the vehicle can be covered to the highest possible extent by the at least one first sensor. The method advantageously makes it possible to identify objects located on the roadway ahead of the vehicle in the direction of travel earlier when the vehicle is driving round a bend or to still detect these when driving round a bend.

The use of map data to determine the course of the roadway thereby makes it possible to determine in a particularly reliable and timely manner whether the roadway has a bend in the direction of travel of the vehicle.

The adaptation of the at least one first sensor can include an adaptation of an angular alignment of the at least one first sensor, typically an adaptation in the transverse direction of the vehicle, by means of at least one adjusting apparatus. In a preferred embodiment, the at least one adjusting apparatus comprises an electric motor, in particular an electric stepping motor. The said embodiments enable the adaptation of the at least one first sensor to be executed in a simple manner and for a plurality of different sensors.

In a further embodiment, the adaptation of the at least one first sensor includes an adaptation of a beam path of electromagnetic waves emitted and/or received by the at least one first sensor. In this case, the adaptation of the beam path of the electromagnetic waves emitted by the at least one first sensor includes an adaptation of an irradiation field of at least one antenna of the at least one first sensor. These embodiments have the advantage that no mechanical elements are required for alignment of the detection range in the direction of the course of the bend and therefore the mechanical stressing of the components can be reduced.

Preferably, a radius of curvature of the bend can additionally be determined from the map data stored in the storage apparatus. For this purpose, the map data can contain information about the roadway geometry, for example, in the form of traverses or clothoids. In this embodiment, the adaptation of the at least one first sensor is accomplished in such a manner that the detection range of the at least one first sensor in the area of the determined bend in the direction of the course of the bend is tracked by a value based on the radius of curvature, preferably by a value corresponding to the radius of curvature. As a result, the tracking of the detection range can be adapted to the highest possible degree to the course of the bend.

In a further embodiment, the adaptation of the at least one first sensor is accomplished in such a manner that the detection range of the at least one first sensor in the area of the determined bend in the direction of the course of the bend is tracked by a predetermined value. This embodiment has the advantage that the tracking of the detection range can also be accomplished in the presence of map data which merely contains information on the direction of the bend.

The storage apparatus is preferably part of a navigation system, particularly preferably a vehicle's own navigation system. Thus, an instantaneous position of the vehicle to determine the course of the roadway can be accomplished by means of the map data in a particularly simple manner.

The application additionally relates to a driver assistance system for a vehicle comprising at least one first sensor, where the at least one first sensor is configured for detecting at least one object within a detection range. In addition, the driver assistance system comprises a first determination apparatus which is configured to determine a course of a roadway at least in a region of an instantaneous environment of the vehicle by means of map data stored in a storage apparatus. Furthermore, the driver assistance system comprises a second determination apparatus configured for determining whether the roadway in a direction of travel of the vehicle has a bend based on the determined course of the roadway. Furthermore, the driver assistance system has an adaptation apparatus configured to adapt the at least one first sensor in such a manner that the detection range of the at least one first sensor in the region of the determined bend is aligned in the direction of the course of the bend if it is determined that the roadway has a bend in the direction of travel of the vehicle. The driver assistance system according to the application has the advantages already mentioned in connection with the method that are not listed again at this point to avoid repetitions.

The at least one first sensor is preferably configured as an acoustic sensor, in particular as an ultrasound sensor, and/or as an electromagnetic sensor, in particular as a transit-time-based sensor, for example, as a radar sensor or as a lidar sensor or as an optical sensor, for example, as an optical camera. The sensors, which are also designated as environment sensors, are provided in large measure for vehicles.

In a further embodiment, the first determination apparatus is configured to determine the course of the roadway by means of at least one second sensor and the second determination apparatus is configured to determine whether the roadway has a bend in the direction of travel of the vehicle, based on the course of the roadway determined by means of the map data and by means of the at least one second sensor. The at least one second sensor is preferably selected from the group consisting of a yaw rate sensor, a steering angle sensor and an optical camera. By this means the said data can be fusioned and plausibilized whereby the accuracy of the identification of the instantaneous traffic situation can advantageously be further increased.

In a further embodiment, the first determination apparatus is additionally configured to determine the course of the roadway by means of data received by a receiving apparatus, where the receiving apparatus is part of a vehicle-to-vehicle communication apparatus and/or a vehicle-to-infrastructure communication apparatus. The second determination apparatus is configured to determine whether the roadway has a bend in the direction of travel of the vehicle, based on the course of the roadway determined by means of the map data and by means of the data received by the receiving apparatus. This embodiment in turn allows a fusioning and mutual plausibilization of the determined data.

The driver assistance system is preferably selected from the group consisting of an active cruise control, which is also designated as (AAC, adaptive cruise control), an emergency braking system and a collision warning system. In particular, in the said driver assistance systems the early identification of objects located in the direction of travel of the vehicle or the further detection of objects when traveling round bends is also advantageous.

The driver assistance systems can thereby receive data of a so-called e-horizon (electronic horizon) of the vehicle. In this context, e-horizon, which is also designated as adasis protocol (ADAS: Advanced Driver Assistance System), is understood to be an interface between the driver assistance system and a navigation system of the vehicle whereby map data of the navigation system are available to the driver assistance system.

A vehicle is also provided in accordance with an embodiment that has a driver assistance system according to one of the foregoing embodiments. The vehicle is preferably a motor vehicle, in particular an automobile or a truck. In addition, a computer program product is provided which, when executed on a processing unit of a vehicle driving on a roadway having at least one first sensor, where the at least one first sensor is configured to detect objects within a detection range, instructs the processing unit to execute the following steps. The processing unit is instructed to determine a course of the roadway at least in a region of an instantaneous environment of the vehicle by means of map data stored in a storage apparatus. In addition, the processing unit is instructed to determine whether the roadway in the direction of travel of the vehicle has a bend based on the determined course of the roadway. If it is determined that the roadway has a bend in the direction of travel of the vehicle, the processing unit is instructed to adapt the at least one sensor in such a manner that the detection range of the at least one first sensor in the region of the determined bend is aligned in the direction of the course of the bend. Furthermore, a computer-readable medium on which a computer program product is provided according to the foregoing embodiments.

The vehicle, the computer program product and the computer-readable medium according to the application exhibit the advantages already mentioned in connection with the method according to the application which are not listed again at this point to avoid repetitions. Embodiments are now explained in detail with reference to the appended figures.

### BRIEF DESCRIPTION OF THE DRAWINGS

The present invention will hereinafter be described in conjunction with the following drawing figures, wherein like numerals denote like elements, and:

FIG. 1 shows a flow diagram of a method for operating a first sensor of a vehicle traveling on a roadway according to one embodiment;

FIG. 2A and FIG. 2B show an example of a traffic situation in which the method according to an embodiment can be used;

FIG. 3 shows a driver assistance system of the vehicle shown in FIG. 2A and FIG. 2B according to an embodiment;

FIG. 4A shows an adapting apparatus of the driver assistance system shown in FIG. 3 according to one embodiment; and

FIG. 4B shows an adapting apparatus of the driver assistance system shown in FIG. 3 according to a second embodiment.

### DETAILED DESCRIPTION

The following detailed description is merely exemplary in nature and is not intended to limit application and uses. Furthermore, there is no intention to be bound by any theory presented in the preceding background or summary or the following detailed description.

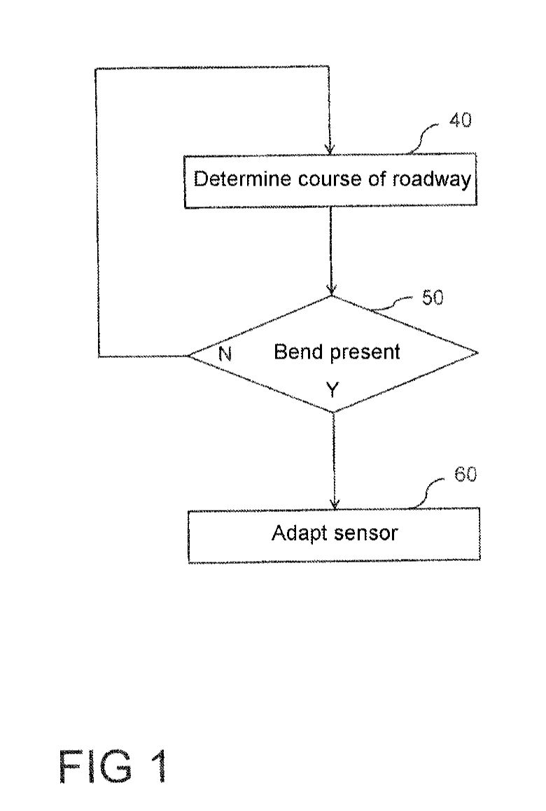

FIG. 1 shows a flow diagram of a method for operating a first sensor of a vehicle traveling on a roadway according to one embodiment of the application. In the embodiment shown the first sensor is configured as an acoustic sensor, in particular as an ultrasound sensor and/or as an electromagnetic sensor, in particular as a radar sensor, lidar sensor or optical camera for detecting objects within a detection range. The vehicle is for example, a motor vehicle, in particular an automobile or a truck.

In a step 40, a course of the roadway is determined at least in an area of the instantaneous environment of the vehicle which lies ahead of the vehicle in the direction of travel of the vehicle by means of map data stored in a storage apparatus. The storage apparatus is preferably part of a navigation system of the vehicle. Furthermore, the course of the roadway can be determined by means of data of at least one second sensor and/or by means of data received by a receiving apparatus and said data can be fusioned and plausibilized. The at least one second sensor is selected, for example, from the group consisting of a yaw rate sensor, a steering angle sensor and an optical camera and the receiving apparatus is part of a vehicle-to-vehicle communication apparatus and/or a vehicle-to-infrastructure communication apparatus of the vehicle.

In a step 50 it is determined whether the roadway ahead of the vehicle in the direction of travel of the vehicle has a bend based on the determined course of the roadway. If it is determined that the roadway in the direction of travel of the vehicle has no bend, for example, within a predetermined area, step 40 is executed repeatedly. If, on the other hand, it is determined that the roadway in the direction of travel of the vehicle has a bend, for example, within the predetermined region, in a step 60 the first sensor is adapted in such a manner that the detection range of the first sensor in the area of the determined bend is aligned in the direction of the course of the bend.

The adaptation of the first sensor can include an adaptation of a lateral angular alignment of the first sensor, which is an angular alignment in the vehicle transverse direction, by means of at least one adjusting apparatus. The at least one adjusting apparatus for example, comprises an electric motor, preferably an electric stepping motor. Additionally or alternatively, the adaptation of the first sensor in the case of an electromagnetic sensor can include an adaptation of a beam path of electromagnetic waves emitted and/or received by the at least one first sensor. The adaptation of the beam path of the electromagnetic waves emitted by the first sensor preferably includes an adaptation of an irradiation field of at least one antenna of the first sensor. For example, an irradiation lobe can be generated by adjusting the phase difference between the feed currents of individual antenna elements or by selecting specific antenna elements.

Preferably, a radius of curvature of the bend is additionally determined with map data stored in the storage apparatus and the adaptation of the first sensor is accomplished in such a manner that the detection range in the area of the determined bend is tracked by a value based on the radius of curvature, preferably by a value corresponding to the radius of curvature.

The embodiment shown thus enables an improved identification of the traffic situation by means of digital map data or by means of data of an adasis protocol by controlling the detection range of the environment sensor in a bend situation in order to allow the highest possible degree of object tracking or tracking the course of the roadway. The map data that are available through the adasis protocol thereby make it possible to control the lateral alignment of the detection range of the environment sensor in the form of the first sensor in order to cover the determined bend of the roadway to an improved extent. Due to the expansion of the object and roadway tracking, active safety systems of the vehicle based on environment sensors are improved in their functioning in bend situations. Environment sensors that are tracked in bends on the basis of map data can, for example, further enable the functionality of an ACC driver assistance system in situations in which this is not available in fixed sensors. The map-data-based control of the environment sensors can thereby also detect bend situations when the driver of the vehicle is not yet controlling the vehicle in the bend.

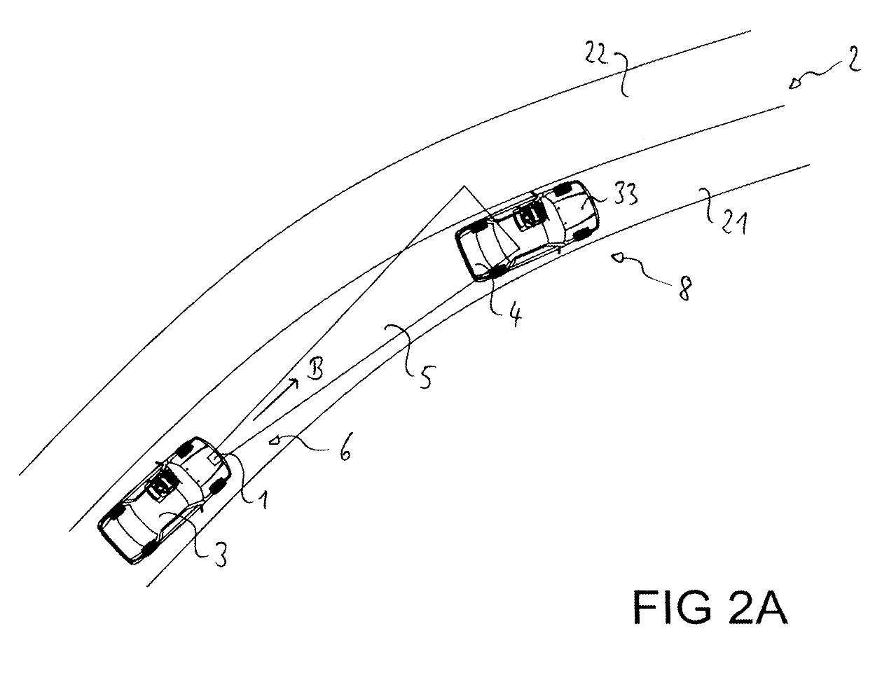

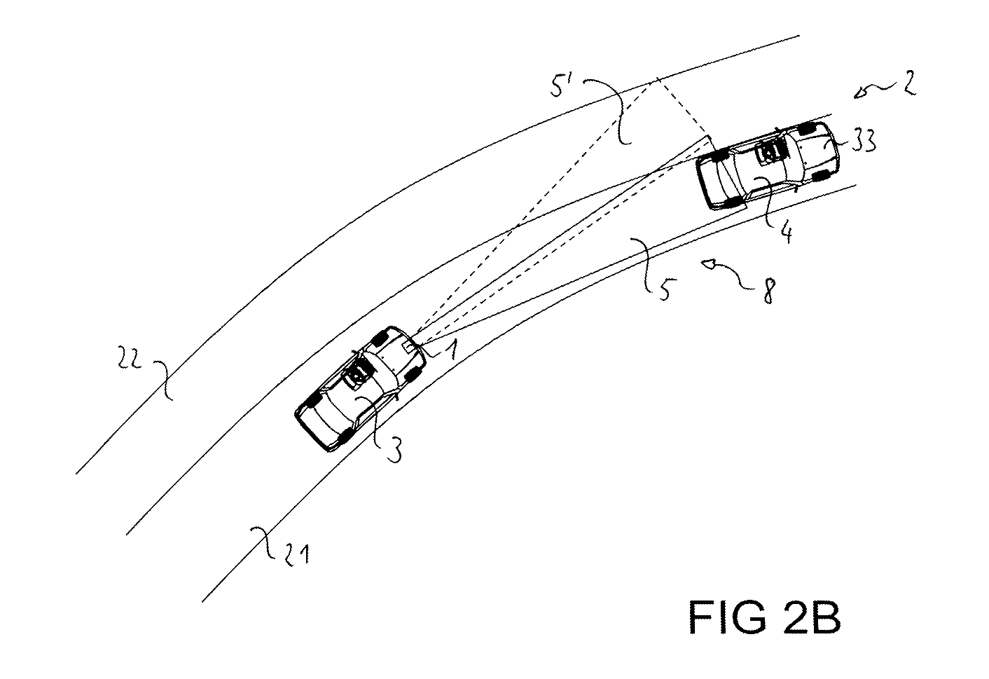

FIG. 2A and FIG. 2B show an example of a traffic situation in which the method according to an embodiment, in particular the method according to the embodiment shown in FIG. 1, can be used. In the traffic situation shown, a vehicle 3, that is, an automobile in the embodiment shown, is traveling in a first lane 21 of a roadway 2 in a direction of travel shown schematically by means of an arrow B. In the direction of travel of the vehicle 3 an object 4 in the form of another vehicle 33 is located ahead of this vehicle in the lane 21. In the situation shown in FIG. 2A, the vehicle 33 is traveling around a bend 8 of the roadway 2. This vehicle 3 is still located ahead of the bend 8.

In addition to the first lane 21, the roadway 2 also has a second lane 22 which can be driven along in the same or opposite direction of travel as the first lane 21. The vehicle 3 has a sensor 1, for example, a radar sensor or a lidar sensor which is configured to identify or detect objects within a schematically depicted detection range 5 in an area of the instantaneous environment 6 of the vehicle 3. The vehicle 33 is located at least partly within the detection range 5 of the sensor 1 and can thus be detected by the sensor 1 and selected as a target vehicle for a distance regulation by means of a driver assistance system of the vehicle 3 in the form of an ACC system not shown in further detail.

FIG. 2B shows the traffic situations shown in FIG. 2A at a later time. Components having the same functions as in FIG. 2A are identified with the same reference numbers and are not explained again hereinafter. The vehicle 3 is located at the beginning of the bend 8 and the vehicle 33 is located at the exit of the bend. By means of map data stored in a storage apparatus not shown, the driver assistance system of the vehicle 3 explained in further detail in the following figures has determined the bend 8 and accordingly aligned the detection range 5 of the sensor 1 in the area of the determined bend 8 in the direction of the course of the bend. As a result, the vehicle 33 is still located in the detection range 5 of the sensor 1 and is thus identified as target vehicle for the distance regulation. In contrast to this, in the case of a fixed sensor 1, the vehicle 33 would be outside an unchanged detection range 5′ shown schematically with a dashed line and as a result, would no longer by detected by the sensor 1.

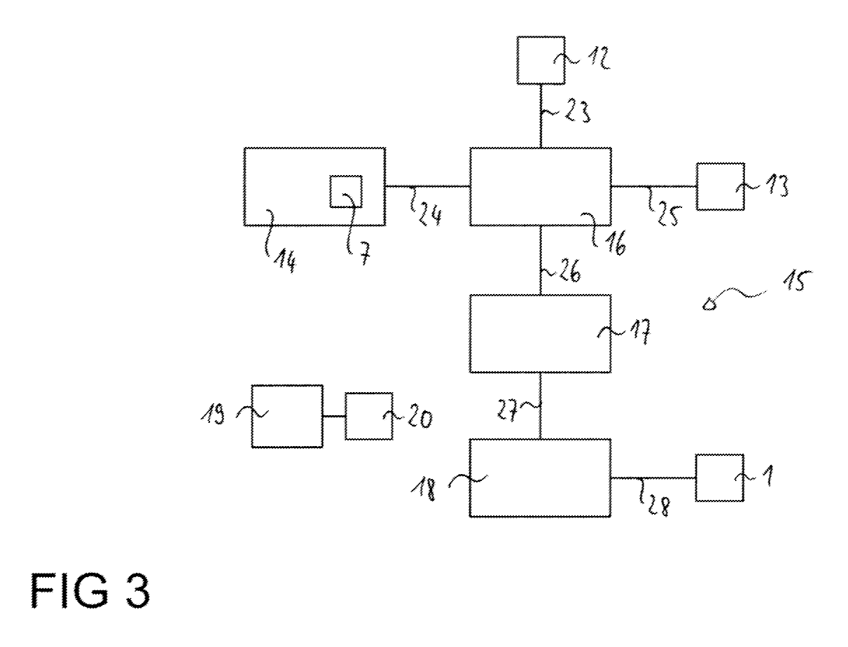

FIG. 3 shows a driver assistance system 15 of the vehicle 3 shown in FIG. 2A and FIG. 2B according to one embodiment of the application. Components having the same functions as in FIG. 2A and FIG. 2B are identified with the same reference numbers and not explained again hereinafter. In addition to the first sensor 1, the driver assistance system 15 comprises a first determination apparatus 16 which is configured to determine a course of the roadway at least in an area of the instantaneous environment of a vehicle by means of map data stored in a storage apparatus 7. In the embodiment shown the storage apparatus 7 is part of a navigation system 14 of the vehicle. A signal line 24 connects the first determination apparatus 16 to the navigation system 14.

In the embodiment shown the first determination apparatus 16 is configured to determine the course of the roadway by means of data of a second sensor 12 of the vehicle. The second sensor 12 is, for example, a yaw rate sensor, a steering angle sensor or an optical camera. A signal line 23 connects the first determination apparatus 16 to the sensor 12. In addition, the first determination apparatus 16 is configured to determine the course of the roadway by means of data received from a receiving apparatus 13. The receiving apparatus 13 in this case is part of a vehicle-to-vehicle and/or vehicle-to-infrastructure communication apparatus of the vehicle. A signal line 25 connects the first determination apparatus 16 to the receiving apparatus 13.

The driver assistance system 15 additionally comprises a second determination apparatus 17 which is configured to determine whether the roadway has a bend ahead of the vehicle in a direction of travel of the vehicle, based on the determined course of the roadway. For this purpose the second determination apparatus 17 is connected via a signal line 26 to the first determination apparatus 16. Furthermore, the driver assistance system 15 has an adaptation apparatus 18 which is configured to adapt the first sensor 1 in such a manner that the detection range of the first sensor 1 in the area of the determined bend is aligned in the direction of the course of the bend if it is determined that the roadway has a bend in the direction of travel of the vehicle. The adaptation apparatus 18 is in this case connected via a signal line 27 to the second determination apparatus 17 and via a connecting element 28 to the first sensor 1.

In addition, in the embodiment shown the driver assistance system 15 comprises a processing unit 19 and a computer-readable medium 20, where a computer program product is stored on the computer-readable medium 20 that, when executed on the processing unit 19, instructs the processing unit 19 to execute the steps mentioned in connection with the embodiments of the method according to the application, in particular the steps of the method according to FIG. 1, by means of the said elements. To this end, the processing unit 19 is connected in a manner not shown in detail directly or indirectly to the corresponding elements. In the embodiment shown, the driver assistance system 15 is an AAC system of the vehicle. In further embodiments the driver assistance system 15 can be configured as an emergency braking system or as a collision warning system.

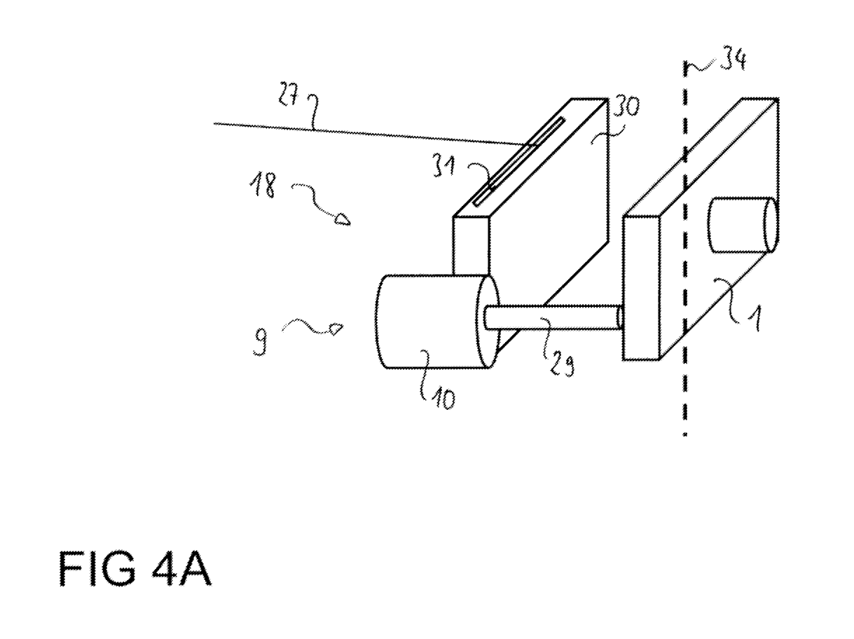

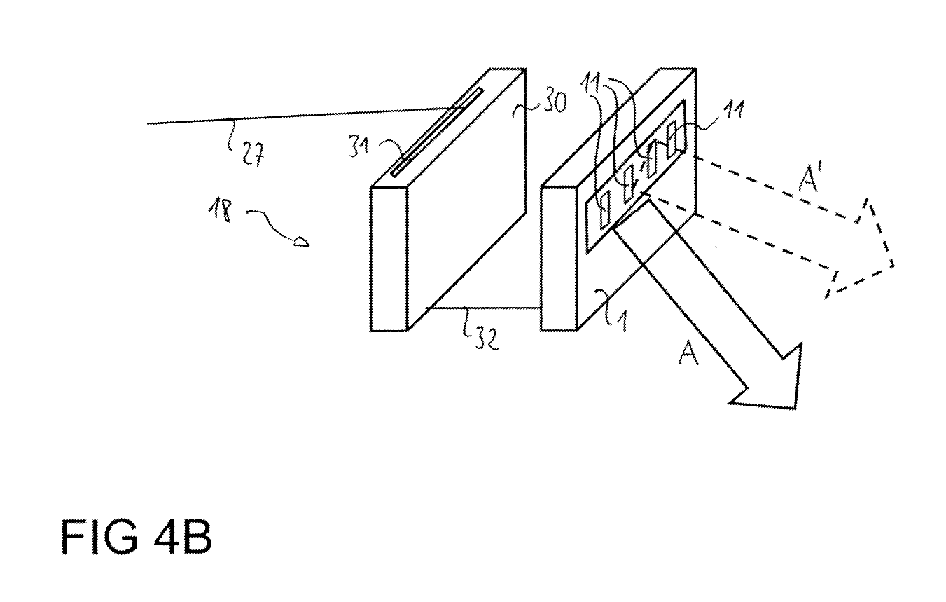

FIG. 4A shows an adaptation apparatus 18 of the driver assistance system shown in FIG. 3 according to a first embodiment. Components having the same functions as in the preceding figures are identified with the same reference numbers and not explained again hereinafter. In the embodiment shown, the adaptation apparatus 18 comprises a mechanical adjusting apparatus 9. The adjusting apparatus 9 includes an electric motor 10, for example, in the form of an electric stepping motor, having a shaft 29. The adjusting apparatus 9 is controlled by means of a control unit 30. The control unit 30 is connected via an interface 31 and the signal line 27 is connected to the further components of the driver assistance system not shown in detail in FIG. 4A, with the result that a map-data based alignment of the sensor 1 when traveling around a bend can be accomplished by means of the adjusting apparatus 9. In the embodiment shown this is accomplished by turning the sensor 1 about an axis of rotation 34 shown schematically and running parallel to a vehicle vertical axis.

FIG. 4B shows an adaptation apparatus 18 of the driver assistance system according to a second embodiment shown in FIG. 3. Components having the same functions as in FIG. 4A are identified with the same reference numbers and not explained again hereinafter. In the embodiment shown a map-data-based electrical adaptation of the irradiation field of the sensor 1 is accomplished. The control unit 30 of the adaptation apparatus 18 is thereby connected via the interface 31 and the signal line 27 to further components of the driver assistance system. Furthermore, the control unit 30 is connected via a control and signal line 32 to the sensor 1. The angular alignment of the irradiation field or the transmission lobe can be adapted by adapting the phase differences between the feed currents of individual antennas 11 of the sensor 1. As a result, the detection range of the sensor 1 can be tracked when traveling around a bend as is depicted schematically by means of an arrow A. In contrast to this, the angular alignment of the irradiation field without electrical matching is shown by means of an arrow A′.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating a first sensor of a vehicle traveling on a roadway, the first sensor configured to detect objects within a detection range and the method comprises:
determining a course of the roadway in a region of an instantaneous environment of the vehicle with map data stored in a storage apparatus;
determining whether the roadway in a direction of travel of the vehicle has a bend based on the course of the roadway,
adapting the first sensor in such a manner that the detection range of the first sensor in the region of the bend is aligned in a direction of the course of the bend if the bend is in the direction of travel of the vehicle.

2. The method according to claim 1, wherein the adapting the first sensor comprises adapting an angular alignment of the first sensor with an adjusting apparatus.

3. The method according to claim 2, wherein the adjusting apparatus comprises an electric motor.

4. The method according to claim 1, wherein the adapting of the first sensor comprises adapting a beam path of electromagnetic waves emitted by the first sensor.

5. The method according to claim 4, wherein the adapting the beam path of electromagnetic waves emitted by the first sensor comprises adapting an irradiation field of an antenna of the first sensor.

6. The method according to claim 1,
wherein a radius of curvature of the bend is additionally determined with the map data stored in the storage apparatus, and
wherein the adapting of the first sensor is accomplished such that the detection range of the first sensor in an area of the bend in the direction of the course of the bend is tracked by a value that is at least partially based on the radius of curvature.

7. The method according to claim 1, wherein the adapting of the first sensor is accomplished such that the detection range of the first sensor in an area of the bend in the direction of the course of the bend is tracked by a predetermined value.

8. A driver assistance system for a vehicle comprising:
a first sensor that is configured to detect an object within a detection range;
a first determination apparatus that is configured to determine a course of a roadway in a region of an instantaneous environment of the vehicle with map data stored in a storage apparatus;
a second determination apparatus that is configured to determine whether the roadway in a direction of travel of the vehicle has a bend based on the course of the roadway; and
an adaptation apparatus that is configured to adapt the first sensor in such a manner that the detection range of the first sensor in the region of the bend is aligned in a direction of the course of the bend if is determined that the roadway has the bend in the direction of travel of the vehicle.

9. The driver assistance system according to claim 8, wherein the first sensor is configured as an acoustic sensor.

10. The driver assistance system according to claim 8, wherein the first sensor is configured as an electromagnetic sensor.

11. The driver assistance system according to claim 8,
wherein the first determination apparatus is configured to determine the course of the roadway with a second sensor, and
wherein the second determination apparatus is configured to determine whether the roadway has the bend in the direction of travel of the vehicle based on the course of the roadway determined with the map data and with the second sensor.

12. The driver assistance system according to claim 11, wherein the second sensor is a yaw rate sensor.

13. The driver assistance system according to claim 8,
wherein the first determination apparatus is further configured to determine the course of the roadway with data received by a receiving apparatus,
wherein the receiving apparatus is part of a vehicle-to-vehicle communication apparatus, and
wherein the second determination apparatus is configured to determine whether the roadway has the bend in the direction of travel of the vehicle based on the course of the roadway determined with the map data and with the data received by the receiving apparatus.

14. The driver assistance system according to claim 8, wherein the driver assistance system is an adaptive cruise control.

15. A computer readable medium embodying a computer program product, said computer program product comprising
an operating program configured to operate a first sensor of a vehicle traveling on a roadway, the first sensor configured to detect objects within a detection range, the operating program configured to:
determine a course of the roadway in a region of an instantaneous environment of the vehicle with map data stored in a storage apparatus;
determine whether the roadway in a direction of travel of the vehicle has a bend based on the course of the roadway,
adapt the first sensor in such a manner that the detection range of the first sensor in the region of the bend is aligned in a direction of the course of the bend if the roadway has the bend in the direction of travel of the vehicle.

16. The computer readable medium embodying the computer program product according to claim 15, wherein the operating program is further configured to adapt an angular alignment of the first sensor with an adjusting apparatus.

17. The computer readable medium embodying the computer program product according to claim 16, wherein the adjusting apparatus comprises an electric motor.

18. The computer readable medium embodying the computer program product according to claim 15, wherein the operating program is further configured to adapting a beam path of electromagnetic waves emitted by the first sensor.

19. The computer readable medium embodying the computer program product according to claim 18, wherein the operating program is further configured to adapt the beam path of electromagnetic waves emitted by the first sensor with an adaptation of an irradiation field of an antenna of the first sensor.

20. The computer readable medium embodying the computer program product according to claim 19,
wherein the operating program is further configured to determine a radius of curvature of the bend with the map data stored in the storage apparatus, and
wherein the operating program is further configured to adapt the first sensor such that the detection range of the first sensor in an area of the bend in the direction of the course of the bend is tracked by a value that is at least partially based on the radius of curvature.
